(19) United States
(12) Patent Application Publication
(10) Pub. No.: US 2018/0311635 A1
(43) Pub. Date: Nov. 1, 2018

(54) METHOD FOR IMMOBILISING A COMPOUND OF INTEREST ON A SUBSTRATE IN A GIVEN PATTERN AND KIT FOR IMPLEMENTING SAME

(71) Applicants: DENDRIS, LABEGE (FR); CENTRE NATIONAL DE LA RECHERCHE SCIENTIFIQUE, PARIS (FR)

(72) Inventors: JEAN-MARIE FRANCOIS, PLAISANCE DU TOUCH (FR); JULIE FONCY, TOULOUSE (FR); EMMANUELLE TREVISIOL, MONTCABRIER (FR); CHILDERICK SEVERAC, TOULOUSE (FR)

(21) Appl. No.: 15/771,271

(22) PCT Filed: Oct. 28, 2015
(86) PCT No.: PCT/FR2015/052911

§ 371 Date: Apr. 27, 2018

(30) Foreign Application Priority Data
Oct. 29, 2014 (FR) 1460398

(51) Int. Cl. B01J 19/00

(52) U.S. Cl. CPC B01J 19/0046; B01J 2219/00529; B01J 2219/00664; B01J 2219/00626; B01J 2219/00608

(57) ABSTRACT

A method for immobilizing a compound of interest on the surface of a substrate in a given pattern using a printing pad. The printing pad is made from a polymer material with a face having a hollow profile that geometrically matches the pattern. The compound of interest is deposited on the surface of walls of a recess. A solution of a compound, capable of forming a link with the substrate and a link with the compound of interest, is confined inside the recess between the substrate and the face of the pad, in a solvent capable of penetrating into the polymer material. The confinement is carried out at a temperature and for a period sufficient to allow the solvent to penetrate the polymer material.

The present invention relates to a method for the immobilization of a compound of interest on the surface of a substrate according to a given pattern, and also to the use of such a method for fabricating biochips. The invention also relates to a kit for carrying out such a method.

A particular field of application of the invention, which will be described in more specific detail in the present description, is the fabrication of DNA biochips, the compound of interest in this case being a nucleic acid molecule.

Such a field of application is, however, in no way limiting with respect to the invention, which also applies to any field in which it may prove to be of interest to deposit and immobilize, according to a predetermined pattern, one or more compounds on a solid substrate or on a semi-solid substrate such as a gel. Throughout the present description, the term “pattern” is intended to mean a three-dimensional geometric arrangement.

DNA biochips make it possible to detect the presence of several tens, or even thousands, of specific nucleotide sequences in a complex biological sample. They are preferably miniaturized systems comprising a substrate on which are deposited, in particular covalently bonded, in an ordered manner, nucleic acid molecules, termed probes, each at a precise place on the substrate. The general principle of a DNA biochip is based on the complementarity of, on the one hand, the nucleotide bases A and T, and, on the other hand, the nucleotide bases G and C, between two DNA strands or a DNA strand and an RNA strand. It consists in placing the biochip in the presence of a population of “target” nucleic acids, and in detecting any complexes of specific hybridization of target nucleic acids with the probes immobilized on the substrate.

From a technical point of view, the fabrication of a biochip comprises two distinct phases: the functionalization of a solid or semi-solid support so as to give it a chemical function allowing subsequent binding of the probe molecules; then the ordered directing of these probe molecules on the surface of the substrate thus functionalized.

With regard to the first phase, various techniques of functionalizing a substrate have been proposed by the prior art. These techniques make it possible to introduce onto the surface of the substrate functions which allow subsequent attachment of the probes. Such a surface functionalization can be carried out by dipping the substrate in a solution of an appropriate chemical compound (Trévisiol, 2003, New Journal of Chemistry, 27, 1713-1719), or by soft lithography such as microcontact printing (Thibault et al., 2006, Microelectronic Engineering, 83, 1513-1516).

With regard to the second phase, the patterns in which the probes are directed depend greatly on the envisaged method of reading the biochip. For example, for fluorescence biochips, the probes can be directed on the surface of the substrate by means of a needle robot or ink jet robot (Barbulovic-Nad et al., 2003, Critical reviews in Biotechnology, 26, 237-259). In this case, the patterns are round spots, the size of which is compatible with the resolution of the fluorescence-reading scanner. In the case of detection without fluorescence labeling, for example by light diffraction, the probes are ordered on the functionalized substrate according to “diffractive” patterns, the size and shape of which are dependent on the diffraction-reading system. The directing of the probes can then for example be carried out by means of a microcontact printing technique.

In any event, these methods for fabricating biochips have the drawbacks of being lengthy, constricting and relatively expensive to carry out.

The present invention aims to overcome the drawbacks of the methods proposed by the prior art for immobilizing a compound of interest on the surface of a substrate according to a predetermined pattern, in particular those set out above, by providing such a method which makes it possible to carry out such an immobilization in a short period of time and with few steps, this being regardless of the pattern according to which the compound is directed on the desired substrate, in particular regardless of whether this pattern is a simple spot or a diffraction grating.

To this effect, the present invention provides a method for the targeted immobilization of a compound of interest on the surface of a solid or semi-solid substrate, according to a given pattern, that is to say according to a given three-dimensional geometric arrangement. This method comprises the following successive steps:
on a printing pad made from polymer material, in particular from elastomer material, termed pad, comprising a face, called printing face, having a profile of recesses that is geometrically complementary to said pattern, deposition of the compound of interest on the surface of walls of at least one recess, preferably of all the recesses, and
confinement, between the substrate and the printing face of the pad, inside said recess, of a solution of a compound, called linker compound, capable of simultaneously forming a bond, in particular a covalent bond, with the substrate and a bond, in particular a covalent bond, with the compound of interest, in solution in a solvent capable of penetrating into the polymer material.

This confinement is carried out at a temperature and for a period of time that are sufficient to allow the solvent comprised inside said recess to penetrate into the polymer material.

It is within the competence of those skilled in the art to determine the time and the temperature of the confinement phase, under the applied pressure conditions, on the basis of their general knowledge, taking in particular into account the characteristics of the solvent and those of the pad. The pressure at which the confinement phase is carried out is preferentially atmospheric pressure, for greater ease of implementing the method according to the invention.

The pattern according to which the compound of interest is immobilized by the method according to the invention on the surface of the substrate preferably extends on one or more restricted zone(s), with controlled location(s), of this surface, in particular in the form of a set of discrete figures.

In particular embodiments of the invention, the solvent is chosen so as to be capable of penetrating into the polymer material at ambient temperature, that is to say at a temperature of between approximately 18° C. and approximately 28° C., at atmospheric pressure. The confinement is then carried out at a temperature and for a period of time that are suitable for ensuring the penetration of the solvent into the polymer material, this period of time being in particular dependent on the type of polymer material constituting the pad, on the size of the recess, on the volume of solution of linker compound contained in the recess, and also on the capacity of the solvent to penetrate into the polymer material.

It has been noted by the present inventors that, after penetration of the solvent into the polymer material, bonds have been formed, on the one hand, between the linker compound and the substrate, and, on the other hand, between the linker compound and the compound of interest, resulting in the immobilization of the compound of interest on the substrate, in an ordered pattern dictated by the profile of recesses of the printing face of the pad. Depending on the linker compound used, these bonds may be covalent or noncovalent.

The method according to the present invention thus makes it possible, entirely advantageously, in a single step that is easy to carry out and in a very short time, between a few seconds and a few minutes, usually less than or equal to 5 minutes, to simultaneously carry out the two phases required for the fabrication of the biochips, that is to say both to functionalize the surface of the substrate and to attach the compound of interest on this surface according to any desired pattern. This applies equally whether the patterns are of millimetric dimensions, of micrometric dimensions or of nanometric dimensions. A gain in time and a cost saving compared with the prior art methods advantageously result from this. In addition, such a method requires a relatively small amount of linker compound, only on the useful zone of the substrate, which the printing face of the pad is intended to face.

The pattern according to which the compound of interest is immobilized on the substrate is formed of protuberances consisting of a stack of molecules of linker compound and of molecules of compound of interest bonded to the latter. It is substantially complementary to the profile of recesses of the printing face of the pad, to within slight dimensional variations due to a slight deformation of the polymer material constituting the pad during the penetration of the solvent into this material. It has been noted by the present inventors that the obtaining of such a pattern results from a directed stacking of molecules of the linker compound, and consequently of the compound of interest which bonds thereto, along the walls of the recesses made in the printing face of the pad, during the confinement phase.

No judgement in advance regarding the mechanism underlying this phenomenon will be made here. However, it can be considered that the penetration of the solvent into the polymer material constituting the pad creates inside the recesses a volume of air generating the formation of a triple line, that is to say an “air/liquid/solid” interface, which results in a superconcentration of molecules of linker compound at the surface of the walls of the recesses, where the molecules of compound of interest are located, and in a phenomenon of vertical convective assembly of these molecules against these walls. When the amount of molecules of the linker compound contained within the recesses is sufficient, in particular when the recesses have nanometric dimensions, the linker compound and the compound of interest fill these recesses, and the pattern formed on the substrate then consists of substantially solid forms. When the amount of molecules of the linker compound confined within the recesses is insufficient to fill the recesses, in particular when the latter have micrometric dimensions, the pattern formed on the substrate consists of substantially hollow forms, reproducing the outline of the recesses.

The method according to the invention is particularly suitable for the fabrication of biochips. In such a field of application, when the compound of interest is an oligonucleotide probe, the biochips fabricated by means of the method according to the present invention have particularly advantageous and entirely surprising properties, linked to the very characteristics of this method. After incubation of such a biochip in the presence of a target oligonucleotide complementary to the oligonucleotide probe immobilized on the substrate, a strong increase in the signals measured after hybridization of the oligonucleotide probe and of the target oligonucleotide is indeed observed, compared with the biochips obtained by means of the prior art techniques, in particular by means of the technique of microcontact printing on a substrate having been prefunctionalized so as to allow the bonding of the oligonucleotide probe (as are described in particular in the publication by Thibault et al, 2005, Journal of Nanobiotechnologies, 3, 7). Such an advantageous result could be due to the directed assembly of the molecules of linker compound along the walls of the recesses made in the printing face of the pad. This directed assembly could increase the number of sites of bonding of the molecules of linker compound to the molecules of compound of interest or, in the case of fluorescence biochips, improve the accessibility of the fluorophores during the fluorescence reading.

According to particular embodiments, the invention also has the following characteristics, implemented separately or in each of their technically effective combinations.

In particular embodiments of the invention, the deposition of the compound of interest on the surface of walls of the recess(es) made in the printing face of the pad is carried out by means of the succession of the following steps:
deposition, on the printing face of the pad, of a solution of said compound of interest; this step will hereinafter be denoted by the expression “pad inking”,
drying of this printing face so as to remove the solvent, and
optionally, removal of the compound of interest present on the printing face of the pad in the zones not constituting the recesses, for example by contact of this printing face with a plate, so as to transfer the molecules of compound of interest onto this plate, and to obtain a configuration in which the compound of interest coats only the surface of the walls of the recess(es).

The phase of confinement of the linker compound between the substrate and the printing face of the pad, inside the recess(es), can for its part be carried out by deposition of the solution comprising the linker compound on the substrate, and applying the printing face of the pad against the substrate thus covered with the solution of linker compound. This solution is then trapped inside the recess(es) formed in the printing face of the pad, in contact with the compound of interest which covers the walls of this or these recess(es). Preferably, the application of the printing face of the pad against the substrate is carried out such that all of the zones of this printing face not constituting recesses are simultaneously applied against the substrate.

The force with which the printing face of the pad is applied against the substrate covered with the solution of the linker compound is preferably sufficient to obtain contact between the pad and the substrate without, however, crushing the printing surface of the pad. Such crushing occurs when the force exerted uniformly on the back face of the pad is equal to or greater than the Young's modulus (E) multiplied by the surface area squared (s²) of the recess with the smallest surface area which initially comes into contact with the linker compound.

The pad can be made from any polymer material. It may in particular be made from elastomeric polymer material, for example based on silicone, on epoxy or on acrylate, which is crosslinked or partially crosslinked.

This material may in particular be of the curable type, that is to say capable of passing from a relatively fluid liquid state to a solid state, this change in state being carried out for example by crosslinking, for example by increasing the temperature, so as to be able to be fabricated by molding.

In particular embodiments of the invention, the pad is formed from crosslinked polydimethylsiloxane (PDMS).

Alternatively, the pad can be formed from non-elastomeric material, for example from poly(4-methyl-2-pentyne), described in particular in the publication by Demko et al., 2012, ACSNANO, 6, 6890-6896.

The solvent in which the linker compound is dissolved can be any solvent capable, of the one hand, of dissolving the linker compound and, on the other hand, of penetrating into the polymer material constituting the pad. This solvent can in particular be chosen from toluene and tetrahydrofuran.

The linker compound can be any compound comprising at least two functional groups, one functional group of which is capable of forming a bond, in particular but non-limitatively a covalent bond, with the substrate, and one functional group of which is capable of forming a bond, in particular but in a non-limiting manner a covalent bond, with the compound of interest. These two functional groups may be identical, for example may be aldehyde groups.

The linker compound can for example be 1,2-polybutadiene-NH₂.

In particular embodiments of the invention, the linker compound is a dendrimer, in particular a phosphorus-comprising dendrimer having a central nucleus and comprising said functional groups at its periphery.

This dendrimer preferably has a size of between 1 and 20 nm, for example between 6 and 8 nm in diameter.

In general, dendrimers are hyperbranched isomolecular polymers of which the size, topology and molecular weight can be rigorously controlled during their formation. The dendrimer molecule, which is generally spherical above a certain size, results from the repeated radial branching of monomers from a central nucleus. The biochips of which the spacer arms are dendrimers advantageously have a high sensitivity and an improved signal-to-noise ratio compared with those with other spacer arms, in particular because the dendrimers make it possible to obtain a high density of probes per unit of surface area of the substrate, and better accessibility of the probes, which leads to hybridization with the target DNA that is not two-dimensional, but instead three-dimensional.

Preferentially, the dendrimer is chosen from those consisting of:
a central layer in the form of a central nucleus P₀, optionally comprising phosphorus, comprising from 2 to 12 functionalized groups,
n intermediate layers, which may be identical or different, each of said intermediate layers consisting of units P₁ corresponding to formula (I) below:

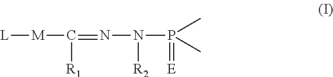

in which:

L is an oxygen, phosphorus, sulfur or nitrogen atom,

M represents one of the following groups:
an aromatic group di-, tri- or tetrasubstituted with alkyl groups, alkoxy groups, unsaturated groups of the C₁-C₁₂ olefinic, azo or acetylenic type, it being possible for all these groups to optionally incorporate phosphorus, oxygen, nitrogen or sulfur atoms or halogens, or
an alkyl or alkoxy group comprising several substituents as defined when M is an aromatic group,

R₁ and R₂, which may be identical or different, represent a hydrogen atom or one of the following groups: alkyl, alkoxy, aryl, optionally comprising phosphorus, oxygen, sulfur or nitrogen atoms or halogens, with R₂ usually being different than R₁,

n is an integer between 1 and 11,

E is an oxygen, sulfur or nitrogen atom, said nitrogen atom possibly being bonded to an alkyl, alkoxy or aryl group, it being possible for all these groups to optionally incorporate phosphorus, oxygen, nitrogen or sulfur atoms or halogens,
an external layer consisting of units P₂, which may be identical or different, and which correspond to formula (II) below:

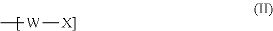

in which:

W represents one of the following groups: alkyl, alkoxy, aryl, all these groups optionally comprising phosphorus, oxygen, nitrogen or sulfur atoms or halogens,

X represents an aldehyde, thiol, amino, epoxide, carboxylic acid, alcohol or phenol group.

In preferred embodiments of the invention, X represents an aldehyde group.

Such dendrimers are in particular described in document WO 03/091304.

For carrying out the confinement step of the method according to the invention, the amount of dendrimers deposited on the substrate can in particular be between 0.1 and 1000 μg per cm² of substrate, for example be approximately equal to 50 μg/cm².

In particularly preferred embodiments of the invention, the linker compound is a phosphorus-comprising dendrimer displaying one or more of the above characteristics, the printing pad is formed from crosslinked PDMS and the solvent used to form the solution of linker compound is tetrahydrofuran or toluene.

In particular embodiments of the invention, the confinement is carried out for a period of time of between 10 seconds and 15 minutes, for example of approximately 5 minutes.

It is also preferentially carried out at ambient temperature, that is to say at a temperature approximately between 18 and 28° C., in particular between 20 and 25° C., preferentially at atmospheric pressure.

The pattern according to which the compound of interest is immobilized on the substrate may be of any type. It may in particular be a uniform pattern, termed spot, or a more complex geometric figure, which may or may not be periodic, or a combination of such patterns.

The substrate on which the compound of interest is immobilized can in particular be used to search, in a medium, for a particular target molecule with which the compound of interest is capable of interacting.

The detection of the interaction of the compound of interest with the target molecule can be carried out using various techniques.

For example, the target molecule can be prelabeled with a detectable label that is conventional in itself, in particular with a fluorescent label such as a fluorophore, so as to generate a detectable and optionally quantifiable signal, in particular a fluorescent signal.

After the substrate on which the compound of interest is immobilized has been brought into contact with the medium that may comprise the target molecule to be detected, the specific interaction between the compound of interest and the target molecule is then simply determined by excitation of the detectable label which has possibly been assembled to the substrate, then by detection of the signal, in particular fluorescent signal, which may then be re-emitted by the label.

The detection of the interaction of the compound of interest with the target molecule can alternatively advantageously be carried out by a technique based on the principle of light diffraction gratings.

The method according to the invention indeed makes it possible to immobilize the compound of interest on the substrate not only according to an ordered pattern allowing subsequent detection by fluorescence, but also according to a pattern allowing detection based on this principle of light diffraction gratings.

Thus, in particular embodiments of the invention, the pattern constitutes a diffracting system, that is to say it consists of a geometric figure capable of diffracting light, comprising, alternately, protruding zones comprising the compound of interest, and zones not comprising the compound of interest.

Such a characteristic proves in particular to be entirely advantageous, in the context of an application of the method according to the invention for the fabrication of biochips, for searching for a target molecule in a medium to be analyzed. The basic principle of the detection of a possible hybridization of such a target molecule with the compound of interest immobilized on the substrate according to a diffractive pattern is in particular described in document WO 2010/029139. Schematically, it is known that, when a grating is illuminated by a light source, the light beam is diffracted by the grating and a diffraction pattern is produced. The diffraction field observed depends, inter alia, on the characteristics of the grating, for instance the period or the thickness of the grating, the reflective index and the wavelength of the light source. The detection of a possible hybridization between the compound of interest immobilized on the substrate according to a diffractive pattern in accordance with the invention, and a possible target molecule present in a sample temporarily placed in contact with the substrate, can thus comprise the following successive steps:
a) measuring an intensity I₀ of a 1^{st}-order diffraction beam of a diffraction field produced by the diffracting system, before placing the substrate in the presence of the sample,
b) placing the substrate in the presence of the sample that may comprise the target molecule to be detected,
c) measuring an intensity I₁ of a 1^{st}-order diffraction beam of a diffraction field produced by the diffracting system after placing the substrate in the presence of the sample,
d) and comparing the measured intensities I₀ and I₁,
a difference in value between these intensities I₀ and I₁ attesting of an interaction between the compound of interest and the target molecule present in the sample.

To this effect, the diffracting system can be illuminated with a collimated monochromatic source, for example a laser, at a wavelength λ selected in the visible or infrared range.

According to the invention, the period of the diffractive pattern is preferably between λ and 2λ, λ corresponding to a wavelength of illumination of the diffracting system, such that only the 1^{st}-order diffracted beam is visible. The lithography technologies used for producing the geometric pattern on the pad are nanometric-scale technologies well known in themselves.

More generally, according to the present invention, each element constituting the pattern can have nanometric dimensions, in particular between approximately 1 nm and approximately 999 nm, or micrometric dimensions, in particular between approximately 1 μm and approximately 999 μm.

For example, the pattern can consist of a set of lines 500 nm in width, with a pitch of 1 μm. Such dimensions allow optimal reading of the intensity of the 1^{st}-order diffraction beam by a diffraction scanner.

The compound of interest immobilized on the substrate can be of any nature or origin. It can in particular be a nucleic acid molecule, a peptide, a protein, a polysaccharide, a lipid, etc. This compound can in particular be modified prior to the implementation of the method according to the invention, in order to introduce therein a functional group capable of reacting, so as to form a bond, for example a covalent bond, with a functional group of the linker compound.

In particular, the compound of interest can consist of a single-stranded or double-stranded nucleic acid molecule, of natural or synthetic origin, for example an aptamer. In particular embodiments of the invention, the nucleic acid molecule is an oligonucleotide obtained by chemical synthesis, using techniques known to those skilled in the art.

The biochips in which nucleic acid molecules are immobilized on the substrate by means of phosphorus-comprising dendrimers as defined above advantageously have excellent stability and particularly high detection sensitivity.

The substrate on which the compound of interest is immobilized can be solid or semi-solid (such as a gel). It can either be rigid or flexible. It is preferably substantially flat. It can for example be chosen from glass slides and silicon, plastic or metal substrates.

Preferentially, the substrate is made from glass, from silicon or from plastic.

When the substrate is made from glass, it is preferably subjected to a pretreatment aiming at attaching to its surface a functional group capable of reacting with the linker compound, for example to a pretreatment by silanisation of its surface, carried out in a manner conventional in itself.

According to another aspect, the present invention relates to the use of a method according to the invention, displaying one or more of the above characteristics, for the fabrication of biochips, in particular of DNA biochips.

For such an application, which requires the immobilization of a plurality of different compounds of interest on the substrate, each one in a desired predetermined pattern, use is preferentially made of a plurality of pads arranged in the form of posts on one and the same base, so as to form a more global object that will be denoted in the present description by the term macrostamp. This macrostamp is preferentially configured such that the printing faces of each of the pads can be simultaneously applied on the substrate. Each of the pads of this macrostamp is devoted to a particular compound of interest, and, at the level of its printing face, has a profile of recesses that is geometrically complementary to a predetermined pattern associated with this compound of interest. Entirely advantageously, the step of confinement of the solution of linker compound between the substrate and the pad, in the recesses, can then be carried out simultaneously for all the compounds of interest to be immobilized on the biochip. The time and the cost necessary for obtaining the biochip are as a result reduced.

An example of such a macrostamp, comprising a set of posts of millimetric dimensions, each defining a pad according to one embodiment of the invention, and the end face of which is nanostructured so as to form thereon recesses that is geometrically complementary to a given pattern, is in particular described in document EP 2 036 604.

The structuring profiles of the printing face of each of the pads of the macrostamp can be identical or different.

Another aspect of the present invention relates to a kit for carrying out a method, according to the invention, for the immobilization of a compound of interest on the surface of a substrate according to a given pattern. This kit comprises:
a printing pad made from polymer material comprising a face, called printing face, having a profile of recesses that is geometrically complementary to said pattern, and
a compound called linker compound capable of simultaneously forming a bond, in particular a covalent bond, with said substrate and a bond, in particular a covalent bond, with said compound of interest, optionally in solution in a solvent capable of penetrating into said polymer material.

The printing pad, the compound of interest, the linker compound and the solvent can have one or more of the characteristics described above with reference to the method according to the invention.

The kit can also comprise one or more of the following elements:
a rigid or flexible, solid or semi-solid substrate that can have one or more of the characteristics described above, optionally having undergone a pretreatment aiming at allowing the linker compound to attach to the surface of said substrate, for example by silanization,
optionally, reagents for such a pretreatment of the substrate, for example by silanization,
operating instructions for carrying out a method according to the invention.

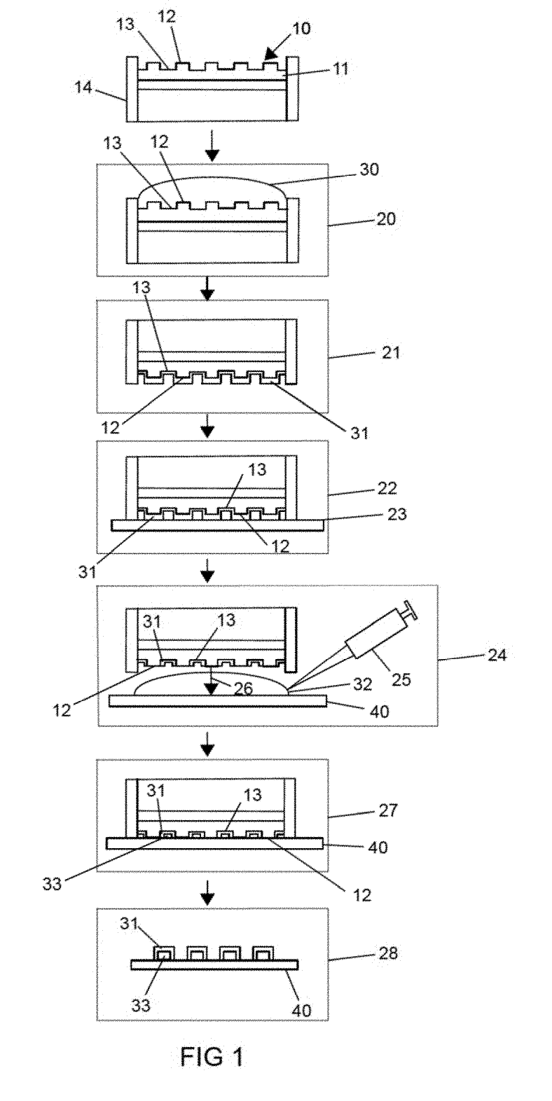

The characteristics and advantages of the invention will emerge more clearly in the light of the implementation examples below, provided simply by way of illustration and which are in no way limiting with respect to the invention, with the support of FIGS. 1 to 10, in which:

FIG. 1 shows diagrammatically the various steps of a method according to one particular embodiment of the invention;

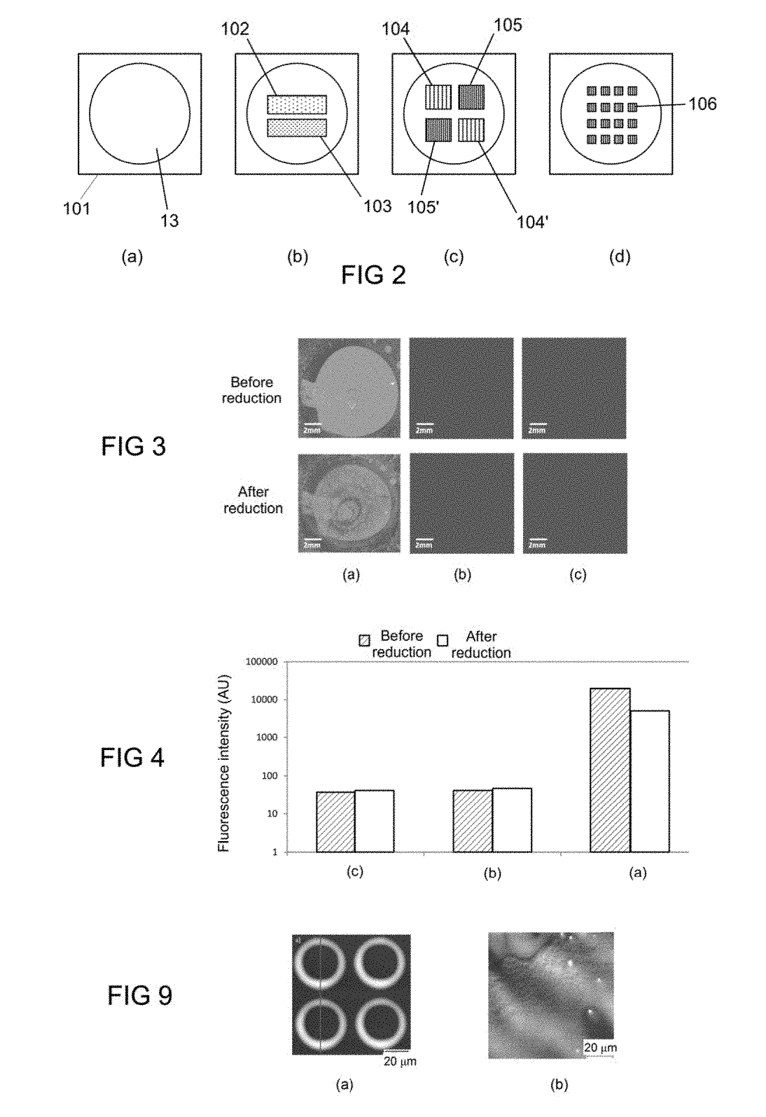

FIG. 2 shows diagrammatically various variants of printing pads that can be used in a method according to the invention;

FIG. 3 shows images, obtained by a fluorescence scanner, of the substrate after carrying out a method according to the invention by means of a pad comprising a single recess with a circular cross-section, the compound of interest being a fluorescent oligonucleotide and the linker compound a phosphorus-comprising dendrimer, respectively before and after a step of treating the substrate in order to reduce the imine functions present between the oligonucleotide and the dendrimer and between the dendrimer and the substrate, (a) the pad having been inked with a solution of the oligonucleotide, (b) the pad having been inked with a solution without oligonucleotides, (c) the pad not having been inked;

FIG. 4 shows a graph representing the fluorescence intensity measured for each of the substrates the images of which are shown in FIG. 3;

FIG. 5 shows images, obtained by a fluorescence scanner, of the substrate after carrying out a method according to the invention by means, respectively, of two pads having a profile of recesses comprising line-shaped recesses (lines of width 15 μm with a pitch of 30 μm for the pad T1, and lines of width 10 μm with a pitch of 20 μm for the pad T2), the compound of interest being a fluorescent oligonucleotide and the linker compound a phosphorus-comprising dendrimer;

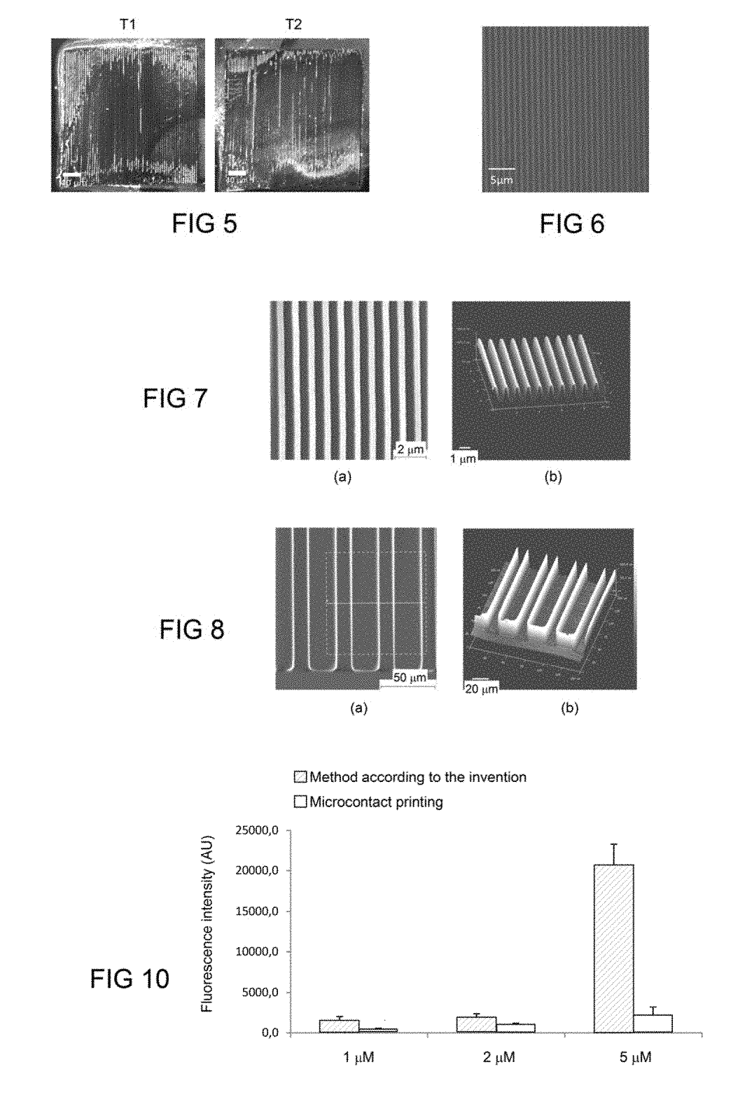

FIG. 6 shows an image, obtained by fluorescence microscope, of the substrate after carrying out a method according to the invention by means of a pad having a profile of recesses comprising line-shaped recesses of width 500 nm with a pitch of 1 μm, the compound of interest being a fluorescent oligonucleotide and the linker compound a phosphorus-comprising dendrimer;

FIG. 7 shows images of the substrate of FIG. 6, obtained by atomic force microscopy, (a) viewed from above and (b) in perspective view;

FIG. 8 shows images obtained by atomic force microscopy, (a) viewed from above and (b) in perspective view, of the substrate after carrying out a method according to the invention by means of a pad having a profile of recesses comprising line-shaped recesses of width 20 μm with a pitch of 40 μm, the compound of interest being a fluorescent oligonucleotide and the linker compound a phosphorus-comprising dendrimer;

FIG. 9 shows images obtained by atomic force microscopy, viewed from above, of the substrate after carrying out some of the steps of a method according to the invention, not using a compound of interest, by means of a pad having a profile of recesses comprising recesses with a circular cross-section of diameter 20 μm, (a) the linker compound being 1,2-polybutadiene-NH₂ and the solvent being toluene, (b) the linker compound being a phosphorus-comprising dendrimer and the solvent being ethanol; and

FIG. 10 shows a graph representing the fluorescence intensity measured for DNA biochips obtained by means of a method in accordance with the invention, or by means of a prior art method by microcontact printing, after hybridization of the oligonucleotide probe immobilized on the biochip with a fluorescent complementary target oligonucleotide, for various concentrations of oligonucleotide probe (1, 2 and 5 μM).

The various steps of a method according to one embodiment of the invention, for the immobilization of a compound of interest on a solid or semi-solid substrate in a given pattern, are shown in FIG. 1.

This method uses a pad 10, made from elastomeric polymer material, for example from crosslinked PDMS. This pad 10 can be produced by any method that is conventional in itself. For example, it can be produced by means of a mold, for example made from polyurethane, from silicon or from epoxy resin, of appropriate shape, by filling this mold with a precursor of the material constituting the pad 10 in liquid form, and curing, in particular by heat-crosslinking.

The pad 10 is formed of a membrane 11, placed in a carrier structure 14, for example made from PLEXIGLASS®. A plurality of recesses 13 are made in one face, called printing face, 12 of this membrane 11, according to a profile that is geometrically complementary to the desired pattern for the immobilization of the compound of interest on the substrate.

In a first phase, the method according to the invention comprises the deposition of the compound of interest on the surface of the walls of the recesses 13. This deposition can be carried out by the succession of the following steps.

In a first step, shown in 20 in FIG. 1, a drop 30 of a solution of the compound of interest in a solvent is deposited on the printing face 12 of the pad 10.

The drop 30 is then removed from the pad 10 having thus been inked, and said pad is dried, in particular under a stream of nitrogen, so as to obtain, as indicated in 21 in FIG. 1, a pad 10 the surface of the printing face 12 of which, including in the recesses 13, is coated with a layer 31 of the compound of interest, which remains attached to this surface. In FIG. 1, for better visibility of the layer 31, the latter is represented with a thickness that is much greater than its actual thickness. Likewise, the relative sizes of all the elements represented in FIG. 1 are not representative of the reality, some elements being artificially enlarged so as to facilitate understanding.

The next step, shown in 22 in FIG. 1, consists in removing the compound of interest from the zones of the printing face 12 distinct from the recesses 13. For this purpose, the printing face 12 of the pad 10 is applied onto a solid surface such as a glass slide 23, according to “microcontact printing” technology. The molecules of the compound of interest in contact with the slide 23 are transferred onto the latter. The compound of interest then remains solely present on the surface of the walls of the recesses 13.

The next phase of the method according to the invention consists of a confinement of a solution of a linker compound between the substrate 40 and the pad 10, in the recesses 13.

For this purpose, as indicated in 24 in FIG. 1, a drop 32 of a solution of the linker compound in the solvent, for example tetrahydrofuran or toluene, is deposited on substrate 40, for example by means of a pipette 25. The printing face 12 of the pad 10 is then applied, as indicated in 26, against the surface of the substrate 40.

This operation has the effect of trapping a volume 33 of the solution of the linker compound between the substrate 40 and the pad 10, in the recesses 13, as shown in 27 in FIG. 1. The linker compound is placed there in the presence of the layer 31 of the compound of interest arranged at the surface of the walls of the recesses 13. The confinement is maintained until the solvent has penetrated through the pad 10. During this confinement phase, the molecules of the linker compound are forced to assemble to the substrate 40. Simultaneously, the molecules of compound of interest are transferred from the surface of the pad 10 onto the molecules of linker compound.

At the end of this confinement phase, after removal of the pad 10, a stack of molecules of the linker compound 34 and of molecules of the compound of interest 31 is obtained on the substrate 40, as indicated very diagrammatically in 28 in FIG. 1. The compound of interest is thus immobilized on the substrate 40 in a pattern that is the inverse of the profile of recesses 13 of the pad 10.

The implementation of all of these steps has advantageously been simple and fast.

FIG. 2 shows diagrammatically various examples of profiles of recesses 13 of pads 10 that can be used in accordance with the present invention.

In a first example, shown in (a) in FIG. 2, the pad 101 has a single recess 13. The compound of interest is then immobilized on the substrate 40 in the form of a spot.

In a second example and a third example, both shown in (b) in FIG. 2, two distinct pads 102, 103 show, respectively, the following profiles of recesses: a network of recesses of circular cross-section and of diameter 5 μm, with a pitch of 10 μm (pad 102); a network of recesses of circular cross-section and of diameter 20 μm, with a pitch of 20 μm (pad 103).

In a fourth example and a fifth example, both shown in (c) in FIG. 2, four distinct pads 104, 104′ and 105, 105′ show, respectively, the following profiles of recesses: a network of recesses in the form of lines of width 15 μm, with a pitch of 30 μm (pads 104, 104′); a network of recesses in the form of lines of width 10 μm, with a pitch of 20 μm (pads 105, 105′).

In a sixth example, shown in (d) in FIG. 2, sixteen distinct and identical pads 106 show a profile of recesses consisting of a network of recesses in the form of lines of width 500 nm with a pitch of 1 μm.

Various examples of implementation of the method according to the invention are described below, in the context of the fabrication of DNA biochips, in which are immobilized, on the substrate 40, as compounds of interest, oligonucleotide probes intended for the detection, in a given sample, of complementary target oligonucleotides.

A. Materials and Methods

Biological Material

All of the oligonucleotides used in the examples below are used in a phosphate buffer solution (Na₂HPO₄) at 0.3 M, pH 9. Their respective sequences are the following:

Oligonucleotide labeled with a fluorophore
(SEQ ID NO: 1):
F1: 5′-[NH₂]-TAT-ACT-CCG-GGA-AAC-TGA-CAT-CTA-G-
[Cy5]-3′
Oligonucleotide probe (HSP12 gene fragment)
(SEQ ID NO: 2):

| | |
|---|---|
| S: | 5′-[AmC6F]-AATATGTTTCCGGTCGTCTC-3′ |

wherein AmC6F represents a spacer consisting of a chain comprising six carbon atoms and ending with an NH₂ amine function.

Fluorescently labeled complementary target
oligonucleotide (CC) (HSP12 gene fragment)
(SEQ ID NO: 3):
5′-[Cy5]-GAG-ACG-ACC-GGA-AAC-ATA-TT-3′
Fluorescently labeled non-complementary target
oligonucleotide (NC) (SEQ ID NO: 4):
5′-[Cy5]-TTT-AGC-TTT-TGC-TGG-CAT-ATT-TGG-GCG-GAC-
A-3′

Products and Solvents
For each of the products and solvents of commercial origin used, the suppliers are indicated in table 1 below.

TABLE 1
Commercial origin of the products/solvents used

| Product/solvent | Supplier |
|---|---|
| Sodium phosphate (NaH₂PO₄) | Sigma-Aldrich |
| Sodium borohydride (NaBH₄) | Sigma-Aldrich |
| SSC buffer solution (saline sodium | Corning |
| citrate: 0.3M sodium citrate, 3M NaCl) | |
| Sodium dodecyl sulfate (SDS) | Corning |
| 3-Aminopropyltriethoxysilane (APTES) | Sigma-Aldrich |
| Tetrahydrofuran (THF) | Sigma-Aldrich |
| Ethanol (EtOH) | Sigma-Aldrich |
| Isopropanol | Sigma-Aldrich |
| PDMS (SYLGARD ® 184) | Corning |

The 4^{th}-generation (G4) phosphorus-comprising dendrimers, corresponding to general formula (III) below, are obtained in the following way.

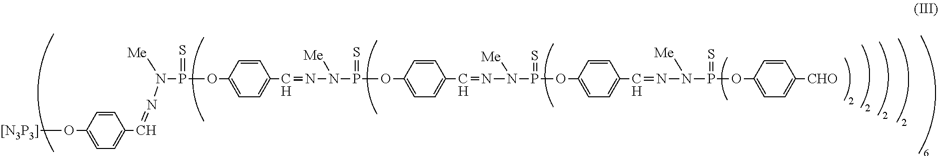

In a first step, the N-methyldichlorothiophosphorhydrazide (IV), a fundamental synthon for obtaining the dendrimer, is synthesized according to the reaction scheme:

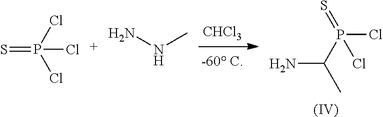

This is carried out by dropwise addition, under argon, of a solution of methylhydrazine (1.9 equiv.) in chloroform CHCl₃, to a solution of trichlorothiophosphine (1 equiv.) in chloroform, while maintaining the temperature of the mixture at −60° C. throughout the addition.

The mixture is then left to slowly return to ambient temperature overnight, while maintaining the stirring. The following day, the reaction is controlled by ³¹P{1H} NMR and left to stir, if necessary, for a further one to two days. The monomethylhydrazine hydrochloride obtained is then filtered under argon using a filtering hollow tube.

The N-methyldichlorothiophosphorhydrazide is stored in solution in chloroform at low temperature (−20° C.) and is subsequently used as it is.

In the next step, the dendrimer with free aldehyde ends (V), which is a precursor of the phosphorus-comprising dendrimers (III), is prepared:

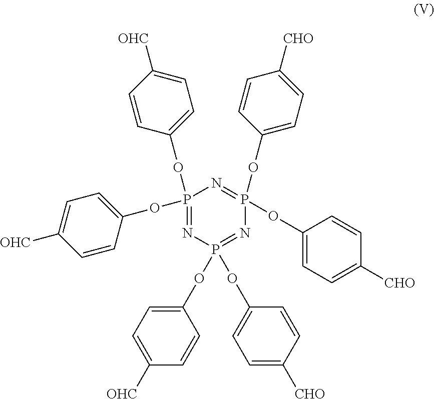 [SMILES: O=Cc1ccc(OP2(Oc3ccc(C=O)cc3)=NP(Oc3ccc(C=O)cc3)(Oc3ccc(C=O)cc3)=NP(Oc3ccc(C=O)cc3)(Oc3ccc(C=O)cc3)=N2)cc1]

To do this, hexachlorocyclotriphosphazene (1 equiv.), 4-hydroxybenzaldehyde (6.6 equiv.) and distilled THF, taken under argon, are mixed in a round-bottomed flask under argon. This mixture is stirred until the solids have completely dissolved.

Potassium carbonate (12 equiv.) is then added spatula by spatula, and the mixture is left to stir overnight at ambient temperature.

The following day, the reaction is controlled by ³¹P{1H} NMR. The potassium carbonate is filtered through filter paper and the filtrate is concentrated in a rotary evaporator to give a white solid. At ambient temperature, the solid is taken up in methanol, filtered through a sinter funnel and rinsed twice with methanol and twice with ether. The dendrimer corresponding to general formula (V) above, termed 0 generation dendrimer, called DP0, is then obtained.

The “fourth-generation” phosphorus-comprising dendrimer, used to functionalize the glass slides, said dendrimer being called DP4 and corresponding to general formula (III) above, is then obtained by repeating one and the same sequence of two reactions, until the 4^{th} generation is obtained:

1) DPn (n representing the dendrimer generation, and n=0 to 3) (1 equiv.), CHCl₃ and the solution of N-methyldichlorothiophosphorhydrazide prepared as described above (7, 13, 27 and 53 equiv., respectively) are mixed under argon.

After stirring for 2 h for the low generations, and 3 h for the high generations, at ambient temperature, the reaction is controlled by ³¹P{1H} NMR.

The mixture is concentrated by half under reduced pressure, by means of a rotary evaporator, transferred into a dropping funnel and added dropwise to a large volume of pentane, in order to precipitate the product.

The precipitate is filtered off using a hollow tube. The solid is taken up in a minimum amount of chloroform, precipitated once again in a 4/1 pentane/diethyl ether mixture and filtered off using a hollow tube. 1^{st}-, 2^{nd}-, 3^{rd}- and 4^{th}-generation dendrimers with chlorine ends, called respectively DP′1, DP′2, DP′3, DP′4, are thus obtained.

2) The DP′n (n=1 to 4) (1 equiv.) and 4-hydroxybenzaldehyde (13, 28, 55 and 110 equiv., respectively), followed by distilled THF taken under argon, are introduced under an argon atmosphere at ambient temperature. Cesium carbonate (20, 40, 60 and 120 equiv., respectively) is then added spatula by spatula. The mixture is left to stir at ambient temperature for 16 h (overnight).

The following day, the reaction is controlled by ³¹P{1H} NMR. The salts are removed by filtration through filter paper for the low generations and then using a centrifuge, and the filtrate is evaporated under reduced pressure to give a white solid.

The solid is dissolved in a minimum amount of chloroform and added dropwise to a large volume of a pentane/ether mixture in order to precipitate the product. The precipitate is filtered off through a sinter funnel. The solid is taken up in chloroform, precipitated again and filtered off. The 1^{st}-, 2^{nd}-, 3^{rd}- and 4^{th}-generation dendrimers with aldehyde ends, called DP1, DP2, DP3 and DP4, are thus obtained.
Substrate

The epoxysilane slides are obtained from NEXTERION® Slide E, Schott.

The glass slides are obtained from Delta Microscopies.

They are modified by silanization, as follows.

The slide is first of all washed in a 2.5 M alcoholic sodium hydroxide solution (50 g of NaOH in a mixture of 200 ml of milliQ H₂O and 300 ml of 96% EtOH), for 30 min at temperature with stirring at 25 rpm. After a return to neutrality by means of three successive washes with milliQ water with stirring at 23 rpm, the slide is immersed in 96% ethanol for 5 min, and is then immersed in the silanisation bath comprising 3′-aminopropyltrimethoxysilane (APTES) at 5% v/v in 96% ethanol EtOH. The slide is left in this bath for 30 min with stirring at 23 rpm at ambient temperature. It is then rinsed several times by immersing it for 5 min in a bath of 96% EtOH, then in a bath of absolute EtOH, still with stirring at 23 rpm. It is then dried by centrifugation (8 min at 500 rpm). Finally, the slide is kept in an oven at 120° C. for 1 h in order to ensure crosslinking of the silane-based coating on the slide.

Printing Pads Production

The pads are made from polydimethylsiloxane (PDMS, SYLGARD® 184). The PDMS is a mixture of two components: an oligomer (silicone) and a crosslinking agent. These are mixed in proportions of 10/1 weight/weight. This mixture is then deposited on silicon molds with various types of patterns, degassed, and then placed at 80° C. for 6 h in order for the PDMS to crosslink.

Inking of the Printing Pads with the Compound of Interest

The inking of the pad is carried out by deposition of a drop of solution of compound of interest on the pad for 1 min. The drop is then removed and the pad is dried under a nitrogen stream.

Removal of the Compound of Interest from the Zones of the Printing Face of the Pad Distinct from the Recesses

The inked pad is brought into contact with a glass slide for 1 min in order to ensure transfer of the compound of interest from the pad to the slide.

Surface-Functionalization of the Substrate by the Microcontact Printing Technique (Prior Art)

Pads are made from polydimethylsiloxane (PDMS, SYLGARD® 184). The pad is inked by deposition of a drop of solution of compound of interest on the pad for 1 min. The drop is then removed and the pad is dried under a nitrogen stream.

The inked pad is then brought into contact with a glass slide for 1 min for transfer of the compound of interest from the surface of the pad to the slide according to the patterns of the pad.

Functionalization by Confinement of the Dendrimers

A drop of 60 μl of solution of G4 phosphorus-comprising dendrimers at 58 μM in tetrahydrofuran (THF) is trapped under the structure of the PDMS pad (optionally inked with compound of interest), then all of the solution is confined on the silanized glass slide until the solvent has penetrated into the polymer material forming the pad (5 min at ambient temperature). During the confinement step, the dendrimers are forced to assemble on the slide according to the pattern that is geometrically complementary to the profile of recesses of the pad.

Deposition of the Oligonucleotide Probes on Slides for DNA Biochip Design (Prior Art)

The oligonucleotide probe is diluted to various concentrations (1, 5, 10, 20 μM) in a phosphate buffer solution (0.3 M Na₂HPO₄, pH 9). 63 examples of each concentration are deposited in the form of spots with an automated depositing device (Q-Array mini, Genetix) using hollow needles. Each spot measures approximately 150 μm in diameter. The deposition is carried out at a relative humidity of 50% and a temperature of 22° C.

Reduction of the Imine Functions after Deposition

After drying overnight in a humid atmosphere, the imine functions present between the dendrimers and the oligonucleotide probes and between the surface of the silanized substrate and the dendrimers are reduced for 3 h using an aqueous solution of sodium borohydride (NaBH₄, 3.5 mg/ml). They are then rinsed three times in a bath of milliQ water for 5 min and, finally, dried under a nitrogen stream or by centrifugation. This step makes it possible to covalently bond the oligonucleotide probes to the dendrimers and the dendrimers to the substrate. The reduction step also makes it possible to convert the aldehyde functions of the dendrimers into inert alcohol functions, thus contributing to the reduction of the background noise.

Biochip Hybridization Protocols

After reduction, the oligonucleotide probes are brought into contact with the (fluorescently labeled) complementary target oligonucleotide CC at a concentration of 100 nM in the 5×SSC buffer, 0.1% SDS, for 30 min at 37° C.

With regard to the hybridization with non-complementary targets, the oligonucleotide probes are brought into contact with the non-complementary target oligonucleotide NC, which is also fluorescently labeled and identical in size to the complementary target oligonucleotide CC. It is used at the same concentration (100 nM).

After the hybridization step, the slides are washed twice (3 min) in a bath of 2×SSC, 0.2% SDS, then once (3 min) in a bath of 0.1×SSC with stirring (1200 rpm). Finally, the slides are dried under a nitrogen stream.

Reading of Fluorescence

Each slide is analyzed using a fluorescence scanner (INNOSCAN® 700, Innopsys) using two excitation wavelengths (532 nm and 635 nm). The photomultipliers (PMTs) of each wavelength are regulated according to the hybridization intensities so that there is no saturation of the fluorescent signal.

Unless otherwise indicated, the scanner parameters are the following: PMT 635: 100%, PMT 532: 100%, light: 50, contrast: 15, balance: 0.

Data Processing

For each spot the average fluorescence intensity, from which the intensity of the background noise is subtracted, is calculated with the dedicated software of the fluorescence scanner (Mapix, Innopsys). The fluorescence intensity after hybridization for each experiment is the average of all of the spots per probe concentration.

Fluorescence Microscopy Image

The fluorescence microscopy images were obtained with the Zeiss LSM 510 NLO microscope. Laser wavelength λ: 633 nm.×40 immersion objective.

Atomic Force Microscopy Analysis

The analysis of the substrates by atomic force microscopy was carried out by means of an AFM Brucker Catalyst Mode SCANASYST® Air microscope, with the following parameters: fo: 50-90 Hz, k: 0.4 N/m.

Detection by Light Diffraction

The diffraction signal is collected before and after the step of incubating the biochip with the target molecule, by means of a diffraction scanner which makes it possible to determine the intensity of a 1^{st}-order diffraction beam of a grating of lines of 500 nm with a pitch of 1 μm. The diffraction scanner parameters are the following: power (p): 1 mW, gain (g): 0.

The TIFF images from the diffraction scanner are analyzed with the Mapix software (Innopsys), which makes it possible to determine the average or median intensity of all the pixels of a precise zone of the image.

Any modification of the periodic arrangement of the gratings, in particular an increase in the height and in the width of the lines of the grating, linked to the interactions of the target molecules on the networks of probe molecules, causes variations in the diffracted signal intensity. These variations are quantified by calculating the gain according to the following formula:

$$Gain ( as \% ) = \frac{{I}_{1} - {I}_{0}}{{I}_{0}} \times 100$$

wherein I₁ represents the intensity of the 1^{st}-order diffraction beam of a grating, measured after interaction with the target molecules, minus the background noise around the grating; and I₀ represents the intensity of the 1^{st}-order diffraction beam of a grating, measured before interaction with the target molecules, minus the background noise around the grating.

### EXAMPLE 1

In this example of implementation of the method according to the invention, a pad comprising a single recess with a circular cross-section 1.5 cm in diameter was used.

The compound of interest is the F1 oligonucleotide having an amine function at its 5′ end and labeled with a Cy5 fluorophore at its 3′ end, at a concentration of 10 μM.

After inking of the pad with this compound of interest, the confinement of the solution of G4 phosphorus-comprising dendrimers, between the silanized glass slide and the pad, is carried out.

The slide is then subjected to a step of reducing the imine functions present between the dendrimers and the oligonucleotide.

Controls in which the pad is inked by means of a solution without oligonucleotide, or in which the pad is not inked prior to the confinement phase, are also carried out.

The images obtained by the fluorescence scanner are shown in FIG. 3. A fluorescent spot with a substantially circular cross-section is observed therein for the slides obtained in accordance with the present invention (a). In comparison, no fluorescence is observed for the controls.

The method according to the invention thus made it possible, in a single step, which moreover is very short, that is to say 5 minutes, to immobilize the oligonucleotide on the glass slide in the desired pattern, by means of the phosphorus-comprising dendrimers.

The fluorescence intensity was also measured. The results obtained are shown in FIG. 4. They confirm the efficiency of the immobilization of the compound of interest on the substrate by means of the method according to the invention. Furthermore, the presence, after reduction of imine functions, of fluorescence at an intensity greater than the controls confirms the bonding of the compound of interest on the dendrimers.

### EXAMPLE 2

In this example, the method according to the invention was applied to the immobilization of the compound of interest on the substrate according to micrometric patterns.

Two pads T1 and T2 were used, said pads having a profile of recesses comprising recesses in the form of lines, said lines having a width of 15 μm with a pitch of 30 μm for the pad T1, and said lines having a width of 10 μm with a pitch of 20 μm for the pad T2. The pitch is defined throughout the present description as the distance between the non-contiguous edges of two adjacent lines, that is to say as the sum of the width of a line and of the width of the zone which separates it from the adjacent line.

The compound of interest is the F1 oligonucleotide having an amine function at its 5′ end and labeled with a Cy5 fluorophore at its 3′ end, at a concentration of 10 μM.

After inking of the pad with this compound of interest, the confinement of the solution of G4 phosphorus-comprising dendrimers, between the silanized glass slide and the pad, is carried out.

The images obtained by the fluorescence scanner are shown in FIG. 5. A grating of fluorescent lines reproducing negatively the profile of recesses of the pads is observed therein, both for the pad T1 and for the pad T2.

### EXAMPLE 3

In this example, the method according to the invention was applied to the immobilization of the compound of interest on the substrate according to a nanometric pattern.

A pad having a profile of recesses comprising recesses in the form of lines having a width of 500 nm with a pitch of 1 μm was used. This type of profile allows the fabrication of biochips suitable for detection by diffraction.

The compound of interest is the F1 oligonucleotide having an amine function at its 5′ end and labeled with a Cy5 fluorophore at its 3′ end, at a concentration of 10 μM.

After inking of the pad with this compound of interest, the confinement of the solution of G4 phosphorus-comprising dendrimers, between the silanized glass slide and pad, is carried out.

The image obtained by the fluorescence microscope is shown in FIG. 6. A grating of fluorescent lines reproducing negatively the profile of recesses of the pad is found therein.

The slide was also examined by atomic force microscopy. The images obtained are shown in FIG. 7, viewed from above (a) and in perspective view (b). It is observed therein that the pattern obtained consists of lines having a width corresponding to a stack of dendrimers. Thus, after the solvent has been evaporated off and has been discharged through the PDMS, the dendrimers fill the space located inside the recesses of the pad.

### EXAMPLE 4

In this example, a pad having a profile of recesses comprising recesses in the shape of lines having a width of 20 μm with a pitch of 40 μm was used.

The compound of interest is the F1 oligonucleotide having an amine function at its 5′ end and labeled with a Cy5 fluorophore at its 3′ end, at a concentration of 10 μM.

After inking of the pad with this compound of interest, the confinement of the solution of G4 phosphorus-comprising dendrimers, between the silanized glass slide and the pad, is carried out.

The slide obtained was examined by atomic force microscopy. The images obtained are shown in FIG. 8, viewed from above (a) and in perspective view (b). It is observed therein that the pattern obtained consists of lines, the dendrimers having stacked along the walls of the recesses of the pad, so that they reproduce the outline of the walls of these recesses. This probably results from the fact that, when the ratio between the width of the recesses and the amount of dendrimers used is high, the amount of dendrimers confined in these recesses is insufficient to fill all of the space therein. The dendrimers then stack in a directed manner along the walls of the recesses.

### EXAMPLE 5

In this example, 1,2-polybutadiene-NH₂ (average molar mass 15000 g/mol) at 1 mg/ml in toluene, or the G4 phosphorus-comprising dendrimers at 1 mg/ml in ethanol, were used as linker compound.

Ethanol does not have the capacity to penetrate into the PDMS. For this solvent, the confinement was carried out at 80° C. for 15 min.

The pad has a profile of recesses comprising recesses of circular cross-section with a diameter of 20 μm.

For this example, no compound of interest was used.

For each of the solutions of the linker compound, the confinement of the solution between the pad and an epoxysilane slide was carried out.

After confinement for 5 min, or 15 min for ethanol, the slides obtained were examined by atomic force microscopy. The images obtained are shown in FIG. 9, viewed from above, for (a) the 1,2-polybutadiene-NH₂ in toluene, (b) the G4 phosphorus-comprising dendrimers in ethanol.

It is observed therein that, when the solvent is toluene, which is capable of penetrating into the PDMS, and the linker compound is 1,2-polybutadiene-NH₂, the method according to the invention allows the immobilization of the linker compound on the substrate, in the form of a network of cylinders of diameter substantially equal to 20 μm. The stacking of the linker compound did indeed occur along the walls of the recesses of the pad.

On the other hand, when the solvent is ethanol, no pattern can be observed on the substrate. No ordered immobilization of the linker compound on the substrate occurred.

### EXAMPLE 6—DNA BIOCHIP

A DNA biochip, suitable for detection both by fluorescence and by diffraction, was fabricated using a method in accordance with the invention, by means of G4 phosphorus-comprising dendrimers as linker compound.

The compound of interest is the S oligonucleotide probe.

The pattern formed on the silanized glass slide is a diffraction grating formed of lines of width 500 nm with a pitch of 1 μm.

After reduction of the imine functions present between the dendrimers and the oligonucleotide probe, the slide is incubated, under hybridization conditions, with, on the one hand, the complementary target oligonucleotide CC, and, on the other hand, the non-complementary target oligonucleotide NC as negative control. These target oligonucleotides are both labeled with the Cy5 fluorophore.

At the end of the incubation step, an analysis of the slide with a fluorescence scanner makes it possible to measure, after incubation with the complementary target oligonucleotide CC, a fluorescence of intensity 729 (AU) and, after incubation with the non-complementary target oligonucleotide NC, a fluorescence of intensity 28 (AU) (average results obtained on 10 different interactions per condition).

This demonstrates in particular that the hybridization of the oligonucleotide probe immobilized on the substrate in accordance with the invention to the complementary oligonucleotides present in a sample, is possible and efficient.

With regard to the detection by diffraction, the diffraction gain obtained is 10.7% after incubation with the complementary target oligonucleotide CC, and −2.3% after incubation with the non-complementary target oligonucleotide NC (average results obtained on 10 different interactions per condition).

Thus, the diffraction gain is positive for the hybridization with a perfectly complementary target oligonucleotide, whereas it is negative after incubation with a non-complementary target oligonucleotide. This result validates the adequacy of the biochips fabricated in accordance with the invention, with respect to light diffraction detection techniques.

### EXAMPLE 7

In this example, the performance levels of the method according to the invention in the field of application of fluorescence DNA biochips, compared with the prior art technique for fabricating biochips by microcontact printing, was evaluated.

For carrying out the method according to the invention, the linker compound is the G4 phosphorus-comprising dendrimer, and the solvent is THF. The pattern formed on the silanized glass slide is a spot 1.5 cm in diameter.

The deposition of the compound of interest by microcontact printing is carried out in a manner that is conventional in itself, on a silanized glass slide on which G4 phosphorus-comprising dendrimers have been attached beforehand.

For the two techniques (method according to the invention and microcontact printing), the compound of interest is the S oligonucleotide probe, used at the various following concentrations: 1, 2 and 5 μM.

After reduction of the imine functions present between the dendrimers and the oligonucleotide probe, the slides are placed in the presence, under hybridization conditions, of the complementary target oligonucleotide CC.

The fluorescent signals were analyzed for each slide after this incubation in the presence of the complementary target oligonucleotide CC.

The results obtained are shown in FIG. 10. For each concentration of oligonucleotide probe tested, a strong increase in the fluorescent signals is observed therein for the slides obtained in accordance with the method according to the invention, compared with the slides obtained by the microcontact printing technique of the prior art.

1-12. (canceled)

13. A method for immobilizing a compound of interest on a surface of a substrate according to a given pattern, comprising successive steps of:
on a printing pad made from a polymer material comprising a printing face having a profile of recesses that is geometrically complementary to said given pattern, deposition of said compound of interest on a surface of walls of at least one recess;
confinement of a solution of a linker compound in a solvent inside said recess between said substrate and said printing face of the pad, said linker compound capable of simultaneously forming a bond with said substrate and a bond with said compound of interest, and the solvent capable of penetrating into said polymer material; and
wherein said confinement is carried out at a temperature and for a period of time to allow the solvent inside said recess to penetrate into said polymer material.

14. The method as claimed in claim 13, wherein the printing pad is made from an elastomeric material.

15. The method as claimed in claim 13, wherein the solvent is chosen from a group consisting of toluene and tetrahydrofuran.

16. The method as claimed in claim 13, wherein the linker compound is a phosphorus-comprising dendrimer having a central nucleus and comprising, at its periphery, a functional group capable of forming a covalent bond with said substrate and a functional group capable of forming a covalent bond with said compound of interest.

17. The method as claimed in claim 13, wherein the confinement is carried out for a period of time of between 10 seconds and 15 minutes.

18. The method as claimed in claim 13, wherein said given pattern constitutes a diffraction grating.

19. The method as claimed in claim 13, wherein said compound of interest is chosen from a group consisting of a nucleic acid molecule, a peptide, a protein, a polysaccharide and a lipid.

20. The method as claimed in claim 13, wherein said substrate is made from glass.

21. The method as claimed in claim 13, wherein said substrate is made from silicon.

22. The method as claimed in claim 13, wherein said substrate is made from plastic.

23. A method of fabricating biochips comprising a step of using a method as claimed in claim 13.

24. The method of fabricating biochips as claimed in claim 22, wherein the biochips are DNA biochips.

25. A kit for performing steps of a method for immobilizing a compound of interest on a surface of a substrate according to a given pattern as claimed in claim 13, comprising:
a printing pad made from a polymer material comprising a printing face having a profile of recesses that is geometrically complementary to said given pattern; and
a compound capable of simultaneously forming a bond with said substrate and a bond with said compound of interest.

26. The kit as claimed in claim 25, comprising a solid or semi-solid substrate.

27. The kit as claimed in claim 25, comprising instructions for performing the steps of the method for immobilizing said compound of interest on the surface of said substrate according to said given pattern.

28. A kit as claimed in claim 25, wherein a solution of said compound capable of simultaneously forming the bond with said substrate and the bond with said compound of interest is in a solvent, the solvent capable of penetrating into said polymer material.

29. The kit as claimed in claim 25, comprising reagents to pretreat said substrate to facilitate am attachment of the linker compound on the surface of said substrate.

30. The kit as claimed in claim 29, comprising silanization reagents.


SEQUENCE LISTING (4 sequences)

SEQ ID NO: 1 - DNA, 25 bp, Artificial sequence
  Synthetic oligonucleotide F1
tatactccgggaaactgacatctag

SEQ ID NO: 2 - DNA, 20 bp, Artificial sequence
  Oligonucleotide probe S
aatatgtttccggtcgtctc

SEQ ID NO: 3 - DNA, 20 bp, Artificial sequence
  Complementary target oligonucleotide CC
gagacgaccggaaacatatt

SEQ ID NO: 4 - DNA, 31 bp, Artificial sequence
  Non-complementary target oligonucleotide NC
tttagcttttgctggcatatttgggcggaca